(19) United States
(12) Patent Application Publication
(10) Pub. No.: US 2026/0298609 A1
(43) Pub. Date: Oct. 1, 2026

(54) DISTORTION DETECTING DEVICE

(71) Applicant: TDK CORPORATION, Tokyo (JP)

(72) Inventors: Masanori KOBAYASHI, Tokyo (JP); Ken UNNO, Tokyo (JP); Tetsuo HATA, Tokyo (JP); Tetsuya SASAHARA, Tokyo (JP); Lucie OUEDRAOGO, Tokyo (JP)

(73) Assignee: TDK CORPORATION, Tokyo (JP)

(21) Appl. No.: 19/629,362

(22) Filed: Mar. 26, 2026

(30) Foreign Application Priority Data
Mar. 27, 2025 (JP) 2025-054073

(51) Int. Cl. G01B 7/16

(52) U.S. Cl. CPC G01B 7/18

(57) ABSTRACT

Provided is a distortion detecting device. The distortion detecting device includes a first metal member having a plate form, a distortion gauge including a first distortion resistance film and provided on one surface of the first metal member, and an additional member provided on an other surface of the first metal member such that the additional member and the distortion gauge are at least partially facing each other across the first metal member.

### CROSS-REFERENCE TO RELATED APPLICATIONS

The present application claims a priority to Japanese patent application No. 2025-054073 filed on Mar. 27, 2025, which is incorporated herein by reference in its entirety.

### BACKGROUND

The present disclosure relates to a distortion detecting device.

A technology for measuring distortion of a member which holds or binds an object using a member provided with a distortion detector is known. For example, Patent Document 1 discloses a device for regulating temperature of a battery pack to maintain a binding pressure of the battery pack at an appropriate level by binding the battery pack using a binding band provided to the distortion detector to detect a change in the binding pressure of the battery pack by detecting the distortion of the binding band using the distortion detector.

In this type of device, the distortion detector can also detect a distortion of the member where the distortion detector is provided by detecting a distortion generated from stretching and shrinking caused by the change in the object condition such as deformation of the object. In general, the easier the member having the distortion detector deforms; for example, the thinner the metal plate when the distortion detector is made of a metal plate, the easier the member distorts, and the higher the sensitivity of the distortion detector against the deformation of the object.

When the distortion detector becomes thinner, due to the change in a state of the object such as deformation, a force in an opposite direction with respect to the force acting on the member, to which the distortion detector is provided, is applied to the distortion detector. Thus, regarding the change in the state of the object such as deformation, an amount of distortion detected by the distortion detector becomes smaller, that is, the sensitivity may be lowered.

### Prior Art Document

### Patent Document

Patent Document 1:JP Patent Application Laid Open No.2016-39076

### SUMMARY

A distortion detecting device according to the present embodiment, including: a first metal member having a plate form, a distortion gauge including a first distortion resistance film and being provided on one surface of the first metal member, and an additional member arranged on an other surface of the first metal member such that the additional member and the distortion gauge are at least partially facing each other across the first metal member.

A distortion detecting device according to another aspect of the present disclosure, including: a first metal member having a plate form, a distortion gauge including a first detector and provided on one surface of the first metal member, and an additional member arranged on an other surface of the first metal member such that the additional member and the distortion gauge are at least partially facing each other across the first metal member.

### BRIEF DESCRIPTION OF DRAWINGS

FIGS. 1A to 1C are figures showing a configuration of a distortion detecting device according to the first embodiment of the present disclosure; and FIG. 1A is a plan view, FIG. 1B is a side view, and FIG. 1C is a bottom view.

FIG. 2 is a plan view showing a configuration of a distortion gauge of the distortion detecting device shown in FIG. 1A to FIG. 1C.

FIG. 3 is a figure showing an example of a use of the distortion detecting device shown in FIGS. 1A to 1C.

FIGS. 4A and 4B are figures explaining a force acting on the distortion gauge of the distortion detecting device.

FIG. 5A is a plan view showing a configuration of a distortion detecting device according to the second embodiment of the present disclosure.

FIG. 5B is a plan view showing a configuration of a distortion detecting device according to the third embodiment of the present disclosure.

FIG. 5C is a plan view showing a configuration of a distortion detecting device according to the fourth embodiment of the present disclosure.

FIGS. 6A to 6C are figures showing a configuration of a distortion detecting device according to the fifth embodiment of the present disclosure; and, FIG. 6A is a plan view, FIG. 6B is a side view, and FIG. 6C is a cross-sectional view at a position of V-V shown in FIG. 6A.

FIGS. 7A to 7C are figures showing a configuration of a distortion detecting device according to the sixth embodiment of the present disclosure; and, FIG. 7A is a plan view, FIG. 7B is a side view, and FIG. 7C is a bottom view.

FIG. 8 is a first diagram showing an example of a signal processing circuit used for the distortion detecting device shown in FIG. 7A to FIG. 7C.

FIG. 9 is a plan view of a distortion detecting device according to the seventh embodiment of the present disclosure.

FIG. 10 is a second diagram showing an example of a signal processing circuit used for the distortion detecting device shown in FIG. 9.

FIGS. 11A and 11B are figures showing a configuration of a distortion detecting device according to the eighth embodiment of the present disclosure; and, FIG. 11A is a plan view and FIG. 11B is a side view.

FIG. 12 is a diagram showing a relation between a detected distortion and a length of the first metal member in a longitudinal direction of a third metal member of Examples of the present disclosure.

FIG. 13 is a diagram showing a relation between a detected distortion and a width of the third metal member of Examples of the present disclosure.

FIG. 14 is a diagram showing a relation between a detected distortion and a thickness of a third metal member of Examples of the present disclosure.

FIG. 15 is a diagram showing a relation between a detected distortion and a thickness of a first metal member of Comparative examples of the present disclosure.

FIG. 16 is a diagram showing a relation between a detected distortion and an area ratio of the second metal member and the third metal member in Examples of the present disclosure.

FIG. 17 is a diagram showing a relation between a detected distortion and an amount of position shifting of the second metal member and the third metal member of Examples of the present disclosure.

### DETAILED DESCRIPTION

Below describes the embodiments of the present disclosure by referring to the figures. The below-described embodiments are examples explaining the present disclosure. Configurational elements according to the embodiments of the present disclosure, such as numerical values, shapes, materials, and manufacturing steps, can be modified and/or changed within the scope of the present disclosure as long as such modifications do not cause problems.

The figures of the present disclosure are schematic diagrams, and the shapes and so on shown in the figures may not necessarily precisely represent the actual shapes, etc. This is because the shapes may be modified for explanation.

### First Embodiment

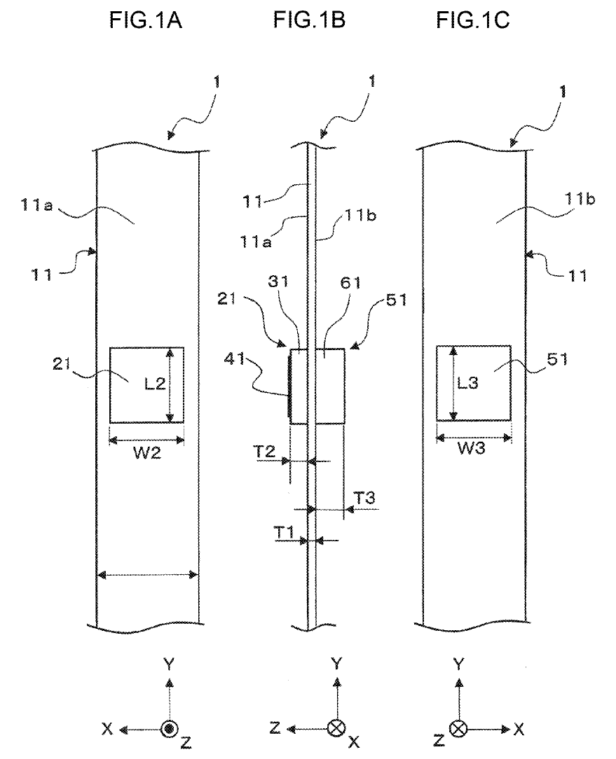

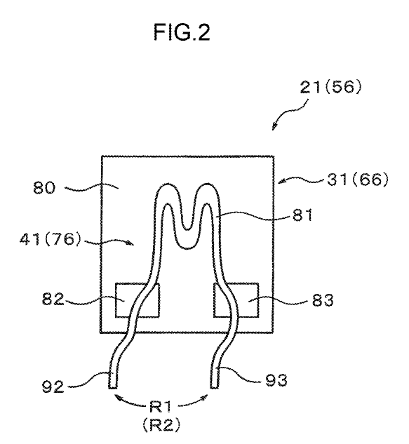

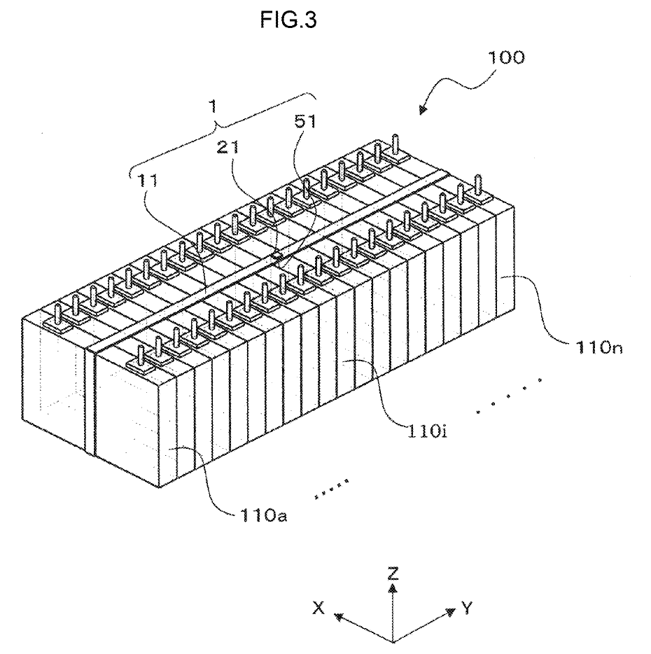

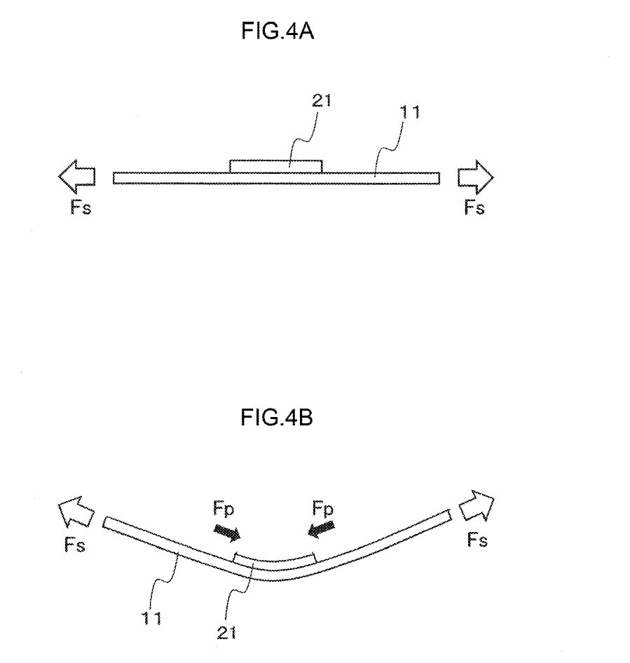

A distortion detecting device 1 according to the first embodiment of the present disclosure is explained by referring to FIGS. 1A to 4B . FIGS. 1A to 1C show the configuration of the distortion detecting device 1 according to the first embodiment of the present disclosure. FIG. 1A is a plan view, FIG. 1B is a side view, and FIG. 1C is a bottom view. FIG. 2 shows the configuration of a distortion gauge 21 of the distortion detecting device 1, FIG. 3 shows one example of a use of the distortion detecting device 1. FIGS. 4A and 4B are figures explaining a force acting on the distortion gauge 21 of the distortion detecting device 1. Note that, in FIG. 1A, a first distortion detector 41 of the distortion gauge 21 is not shown.

As shown in FIG. 1B, the distortion detecting device 1 includes a first metal member 11 of a band-like form, the distortion gauge 21 provided on one surface of the first metal member 11, and an additional member 51 provided on the other surface of the first metal member 11. The distortion gauge 21 includes a second metal member 31 and a first distortion detector 41.

In below description, a width direction of the first metal member 11 is defined as an X-axis direction, a longitudinal direction of the first metal member 11 is defined as a Y-axis direction, and a direction that one surface and the other surface of the first metal member 11 are facing is defined as a Z-axis direction. Also, a Z-axis positive direction is the direction from the other surface (backside 11b) of the first metal member 11 provided with the additional member 51 to one surface (front side 11a) of the first metal member 11 provided with the distortion gauge 21. Also, a direction perpendicular to front and back sides of the first metal member 11, that is, the state viewing the distortion detecting device from the Z-axis direction may be simply referred to as “in plan view”.

The distortion detecting device 1 is used by installing the first metal member 11 to the desired object for measuring distortion caused to the first metal member 11. Thereby, the distortion detecting device 1 detects the change in the state of the object such as deformation or so. For example, as shown in FIG. 3, the distortion detecting device 1 is used for a battery pack 100 to detect shape change such as expansion of the battery pack 100. For example, the battery pack 100 is used as a secondary battery for a stationary energy storage system (ESS), and for a mobile body such as electronic vehicles (EV) and mobile robots.

The battery pack 100 shown in FIG. 3 has an integrated configuration that n numbers of unit cells 1101 to 110n are stacked in a predetermined direction (in FIG. 3, in the Y-axis direction). In such battery pack 100, the first metal member 11 is formed as a binding band, and the first metal member 11 wraps around the battery pack 100 along the outer circumference; thereby, the distortion detecting device 1 is installed to the battery pack 100. The first metal member 11 as the binding band extends in the stacking direction of the unit cells 1101 to 110n to apply a binding force (compression force) in the stacking direction of the unit cells 1101 to 110n; and thereby, the distortion detecting device 1 is installed to the battery pack 100.

In the battery pack 100 to which the distortion detecting device 1 is installed as such, when the unit cells 110i (i = 1 to n) expand, a tensile force acts on the first metal member 11 of the distortion detecting device 1 which causes the distortion in the first metal member 11. Thus, by detecting and measuring this distortion, expansion of the unit cells 110i (i = 1 to n) can be detected and allows to take appropriate response (measure). As such, for example, the distortion detecting device 1 of the present embodiment can be used as a device for measuring the expansion of the battery pack 100.

Note that, in the example of use shown in FIG. 3, the unit cells 1101 to 110n may be accommodated in a case not shown in the figure, or the unit cells 1101 to 110n may be connected using an adhesive, a connecting structure, or a connecting member not shown in the figure. Thereby, the unit cells 1101 to 110n may be integrally configured as one battery pack 100. Even in the case of installing the distortion detecting device 1 to such battery pack 100, the expansion of the battery pack 100 can be detected similarly to the case of binding the unit cells 1101 to 110n using the first metal member 11 of the distortion detecting device 1.

Below describes the configuration of each part of the distortion detecting device 1. The first metal member 11 is a member installed to the object so that the distortion occurs to the first metal member 11 when the object deforms (expansion and shrinking). As shown in FIGS. 1A to 1C, the first metal member 11 is a metal member which is a thin plate of band-like form.

As mentioned in above by referring to FIG. 3, in the present embodiment, the first metal member 11 is a binding band installed to the object by wrapping the first metal member 11 around the object along the outer circumference of the object (battery pack 100). Note that, the first metal member 11 is not limited to the binding band. The first metal member 11 may be in any shape as long as it can be installed to the surface of the object so that the deformation of the object is propagate to the first metal member 11.

A length of the first metal member 11 is, for example, 200 mm or longer, 400 mm or longer, or 1000 mm or longer. A width of the first metal member 11 is, for example, between 1 mm and 100 mm, between 5 mm and 10 mm, or between 6 mm and 9 mm. A thickness T1 of the first metal member 11 is, for example, between 0.01 mm and 1 mm, between 0.05 mm and 0.8 mm, or between 0.1 mm and 0.5 mm.

Materials of the first metal member 11 are not particularly limited. Examples of the materials include simple metals such as Fe, nickel, and aluminum; a stainless steel (SUS) including these; steels such as chromium steel and carbon steel; and alloys such as nickel alloy of invar and Koval. In the present embodiment, the first metal member 11 is configured of austenite-type stainless steel (SUS 304, 316, etc.).

The distortion gauge 21 is provided on one surface (the surface on the Z-axis positive direction side) of the first metal member 11, and detects the distortion of the first metal member 11. As mentioned in above, the distortion gauge 21 includes the second metal member 31 and the first distortion detector 41.

The second metal member 31 is a thin plate-form member having a rectangular plan shape. As shown in FIG. 1A, the second metal member 31 has a length L2 along the longitudinal direction of the first metal member 11 and a width W2 along a width direction which is perpendicular to the longitudinal direction in plan view. Also, as shown in FIG. 1B, the second metal member 31 has a thickness T2 along a thickness direction which is perpendicular to the longitudinal direction and the width direction. The length L2 of the second metal member 31 may be, for example, between 1 mm and 10 mm, between 3 mm and 7 mm, or between 4 mm and 6 mm. The width W2 of the second metal member 31 is, for example, between 1 mm and 10 mm, between 3 mm and 7 mm, or between 4 mm and 6 mm. The thickness T2 of the second metal member 31 may be, for example, between 0.001 mm and 0.5 mm, between 0.005 mm and 0.2 mm, or between 0.01 mm and 0.1 mm.

Materials of the second metal member 31 are not particularly limited. Examples of the materials include simple metals such as Fe, nickel, and aluminum; a stainless steel including these; steels such as chromium steel and carbon steel; and alloys such as nickel alloy of invar and Koval.

The first distortion detector 41 is formed on an upper surface of the second metal member 31 (the surface on the Z-axis positive side, that is, on the surface of the second metal member 31 where the first metal member 11 is not contacting), and detects the distortion of the first metal member 11 via the distortion of the second metal member 31. As shown in FIG. 2, the first distortion detector 41 is fixed on the upper surface of the second metal member 31 via an insulation film 80. The first distortion detector 41 includes a resistance film 81 which is a distortion resistance film for detecting the distortion using a resistance change, and electrodes 82 and 83 arranged at both ends of the resistance film 81 and connected to tapping wires 92 and 93. The voltage corresponding to a resistance R1 of the resistance film 81 of the first distortion detector 41 is detected by an exterior circuit via the electrodes 82 and 83 and the tapping wires 92 and 93; and based on the change in the voltage, an distortion amount of the first metal member 11 is measured.

In the example shown in FIG. 2, the insulation film 80 of the distortion gauge 21 is formed roughly on the entire upper surface of the second metal member 31; however, the insulation film 80 may be formed on the portion only where the resistance film 81 and the electrodes 82 and 83 are formed on the upper surface of the second metal member 31.

The resistance film 81 configuring the first distortion detector 41 can be formed by forming a functional film on the insulation film 80 using a spattering method, a vacuum deposition method, a CVD method, a sol-gel method, etc., and then by carrying out patterning using a photo-patterning method, etc.

The first distortion detector 41 is not limited to the embodiment which includes the resistance film 81 for simply measuring the resistance, and for example, it may be formed by having a Wheatstone bridge circuit or so configured by a plurality of distortion resistance films.

The distortion gauge 21 including the second metal member 31 and the first distortion detector 41 is provided on one surface (the surface on the Z-axis positive direction side) of the first metal member 11, as shown in FIG. 1B. A method for fixing the distortion gauge 21 to the first metal member 11 is not particularly limited, and for example, the second metal member 31 of the distortion gauge 21 may be bonded by welding to the first metal member 11, or the second metal member 31 may be bonded to the first metal member 11 using an adhesive.

As shown in FIGS. 1B and 1C, an additional member 51 is a member which is provided on the other surface (the surface on the Z-axis negative direction side) of the first metal member 11. The additional member 51 is fixed at the position where at least partially facing the distortion gauge 21 across the first metal member 11. The additional member 51 is provided on the other surface of the first metal member 11 such that the additional member 51 and the distortion gauge 21 are at least partially facing each other across the first metal member 11. The additional member 51 includes a third metal member 61.

By providing the additional member 51 such that the additional member 51 and the distortion gauge 21 are at least partially facing each other across the first metal member 11, it is possible to suppress the compression force from acting on the distortion gauge 21. The compression force is acting in the opposite direction of the tensile force acting on the first metal member 11 caused by the shape change (such as the expansion of unit cells 110i (i = 1 to n)) of the battery pack 100. Thus, this enables to increase the distortion amount detected by the distortion gauge 21 in response to the shape change of the battery pack 100. Consequently, the expansion of the battery pack 100 can be measured with high sensitivity.

The third metal member 61 of the additional member 51 is a thin plate-form member having a rectangular plan shape. As shown in FIG. 1C, the third metal member 61 has a length L3 along the longitudinal direction of the first metal member 11 and a width W3 along a width direction which is perpendicular to the longitudinal direction in plan view. Also, as shown in FIG. 1B, the third metal member 61 has a thickness T3 along a thickness direction which is perpendicular to the longitudinal direction and the width direction. The length L3 of the third metal member 61 may be, for example, between 1 mm and 10 mm, between 3 mm and 7 mm, or between 4 mm and 6 mm. The width W3 of the third metal member 61 may be, for example, between 1 mm and 10 mm, between 3 mm and 7 mm, or between 4 mm and 6 mm. The thickness T3 of the third metal member 61 may be, for example, between 0.001 mm and 2 mm, between 0.005 mm and 1 mm, or between 0.01 mm and 0.5 mm.

In the present embodiment, as shown in FIGS. 1A to 1C, the plan shape of the third metal member 61 is the same plan shape as the second metal member 31 of the distortion gauge 21. That is, the length L3 of the third metal member 61 is the same as the length L2 of the second metal member 31 of the distortion gauge 21 (L2 = L3), and the width W3 of the third metal member 61 is the same as the width W2 of the second metal member 31 of the distortion gauge 21 (W2 = W3). Therefore, the second metal member 31 of the distortion gauge 21 and the third metal member 61 of the additional member 51 face each other in its entire surface area across the first metal member 11.

On the other hand, as shown in FIG. 1B, the thickness T3 of the third metal member 61 is thicker than the thickness T2 of the second metal member 31 of the distortion gauge 21 (T2 < T3). Further, the thickness T3 of the third metal member 61 is thicker than the thickness T1 of the first metal member 11 (T1 < T3).

By satisfying such dimensions, it is possible to measure, with high sensitivity, the distortion of the first metal member 11 caused by the force acting on the first metal member 11 due to the shape change of the battery pack 100.

Materials of the third metal member 61 are not particularly limited. Examples of the materials include simple metals such as Fe, nickel, and aluminum; stainless steels including these; steels such as chromium steel and carbon steel; and alloys such as nickel alloy of invar and Koval.

As shown in FIG. 1B, the additional member 51 including the third metal member 61 is a member which is provided on the other surface (the surface on the Z-axis negative direction side) of the first metal member 11. A method for fixing the additional member 51 to the first metal member 11 is not particularly limited, and for example, the third metal member 61 of the additional member 51 may be bonded by welding to the first metal member 11, or the third metal member 61 may be bonded to the first metal member 11 using an adhesive.

The voltage corresponding to the resistance R1 of the resistance film 81 detected by the first distortion detector 41 of the distortion gauge 21 of the distortion detecting device 1 having such configuration is input to a signal processing circuit arranged outside through the tapping wires 92 and 93; then, the voltage is used for the measurement of the distortion amount of the first metal member 11.

As discussed in above, in the distortion detecting device 1 of the present embodiment, the additional member 51 is provided on the surface opposite to where the distortion gauge 21 of the first metal member 11 is provided so that the additional member 51 is at least partially facing the distortion gauge 21 (in the present embodiment, the entire surface of the additional member 51 is facing the distortion gauge 21). Hence, it is possible to reduce the compression force from acting on the distortion gauge 21. The compression force is acting in the opposite direction of the tensile force acting on the first metal member 11 caused by the shape change (such as the expansion of the unit cells 110i (i = 1 to n) of the battery pack 100. Thus, this enables to increase the distortion amount detected by the distortion gauge 21 in response to the shape change of the battery pack 100. Consequently, the expansion of the battery pack 100 can be measured with high sensitivity.

In the case that the additional member 51 is not provided as shown in FIG. 4A, when the first metal member 11 becomes thinner as shown in FIG. 4B, the compression force Fp in the direction opposite to the tensile force Fs acting on the first metal member 11 is applied to the distortion gauge 21. Thus, the distortion amount of the first metal member 11 due to the tensile force Fs acting on the first metal member 11 is detected as a small value by the distortion gauge 21. Particularly in such case, by providing the additional member 51 at the position facing the distortion gauge 21 across the first metal member 11, it is possible to reduce the compression force Fp, which is in the direction opposite to the tensile force Fs acting on the first metal member 11, from acting on the distortion gauge 21. Thus, the distortion caused by the tensile force Fs acting on the first metal member 11 can be detected appropriately.

### Second Embodiment

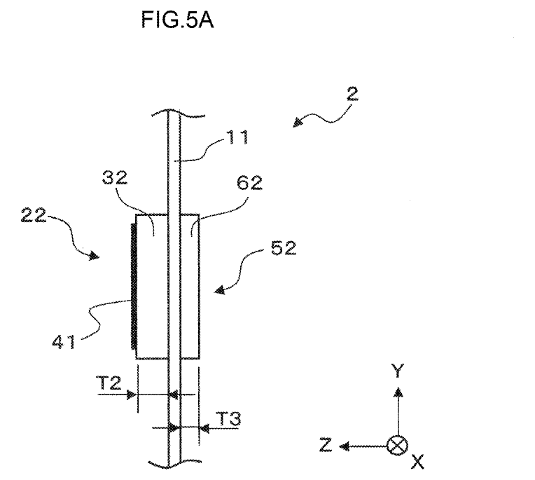

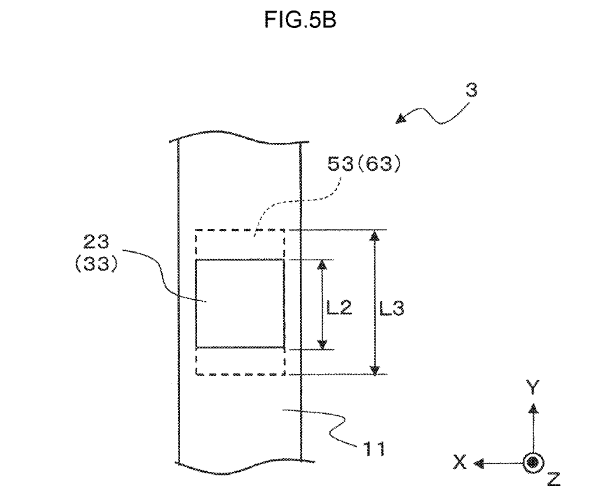

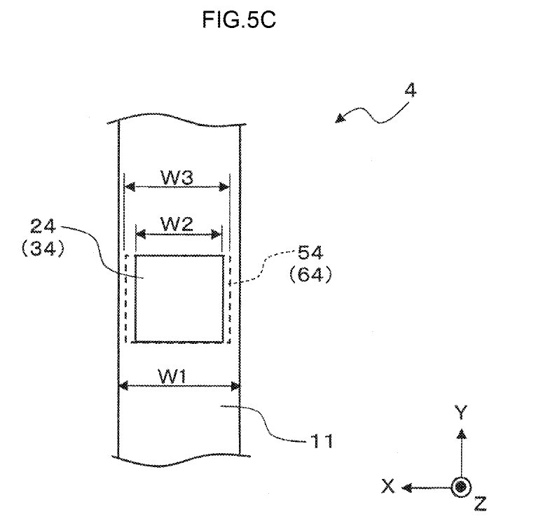

A distortion detecting device 2 of the second embodiment of the present disclosure is explained by referring to FIG. 5A. In the description of the second embodiment, the parts different from the distortion detecting device 1 of the first embodiment are only explained, and the configurations which are similar to the distortion detecting device 1 are given the same numerical references and the explanation of these are skipped. That is, the configurations with no description in below are similar to the corresponding configurations of the distortion detecting device 1 of the first embodiment.

As shown in FIG. 5A, the distortion detecting device 2 of the second embodiment includes the first metal member 11, a distortion gauge 22, and an additional member 52. The distortion gauge 22 includes a second metal member 32 and the first distortion detector 41. The additional member 52 includes a third metal member 62.

In the distortion detecting device 2, the relation between a thickness T2 of the second metal member 32 of the distortion gauge 22 and a thickness T3 of the third metal member 62 of the additional member 52 are different from that of the distortion detecting device 1 of the first embodiment. As shown in FIG. 5A, in the distortion detecting device 2, the thickness T3 of the third metal member 62 is thinner than the thickness T2 of the second metal member 32 of the distortion gauge 22 (T2 > T3).

Even in the case that the thickness T2 of the second metal member 32 and the thickness T3 of the third metal member 62 are in such relation, by providing the additional member 52, the distortion of the first metal member 11 can be detected with high sensitivity, which are similar to the distortion detecting device 1 of the first embodiment.

In the distortion detecting device 2 of the second embodiment, particularly the third metal member 62 of the additional member 52 can be thinned down; hence, the height of the additional member 52 can be lowered, which enables to downsize the distortion detecting device 2, and to reduce space for providing the distortion detecting device 2. The present disclosure may also be carried out in such embodiment.

### Third Embodiment

A distortion detecting device 3 of the third embodiment of the present disclosure is explained by referring to FIG. 5B. In the description of the third embodiment, the parts different from the distortion detecting device 1 of the first embodiment are only explained, and the configurations which are similar to the distortion detecting device 1 are given the same numerical references and the explanation of these are skipped. That is, the configurations with no description in below are similar to the corresponding configurations of the distortion detecting device 1 of the first embodiment.

As shown in FIG. 5B, the distortion detecting device 3 of the third embodiment includes the first metal member 11, a distortion gauge 23, and an additional member 53. The distortion gauge 23 includes a second metal member 33 and the first distortion detector 41 (FIG. 2). The additional member 53 includes a third metal member 63. Note that, in FIG. 5B, the first distortion detector 41 of the distortion gauge 23 is not shown.

In the distortion detecting device 3, the relation between a length L2 of the second metal member 33 of the distortion gauge 23 and a length L3 of the third metal member 63 of the additional member 53 in the longitudinal direction of the first metal member 11 are different from that of the distortion detecting device 1 of the first embodiment. As shown in FIG. 5B, in the distortion detecting device 3, the length L3 of the third metal member 63 is longer than the length L2 of the second metal member 33 of the distortion gauge 23 (L2 < L3). The maximum length of the length L3 of the third metal member 63 of the additional member 53 may be 3 times, 2 times, or 1.5 times the length L2 of the second metal member 33 of the distortion gauge 23.

The distortion gauge 23 (second metal member 33) and the additional member 53 (third metal member 63) are arranged so that the centers of gravity overlap with each other in plan view (the geometric centers of these overlap). In other words, these are arranged at the same position in plan view. Also, the lengths (widths) W2 and W3 (see FIGS. 1A and 1C) of the distortion gauge 23 (second metal member 33) and the additional member 53 (third metal member 63) in the width direction of the first metal member 11 are the same.

Therefore, the distortion gauge 23 (second metal member 33) is entirely facing the additional member 53 (third metal member 63) across the first metal member 11. However, the additional member 53 (third metal member 63) has a portion which is not facing the distortion gauge 23 (second metal member 33) at both ends in the longitudinal direction of the first metal member 11.

As the length L3 of the third metal member 63 of the additional member 53 is longer than the length L2 of the second metal member 33 of the distortion gauge 23 (L2 < L3), it is possible to reduce the compression force from acting on the distortion gauge 23. The compression force is acting in the opposite direction of the tensile force acting on the first metal member 11 caused by the shape change (such as the expansion of unit cells 110i (i = 1 to n) of the battery pack 100. Thus, this enables to further increase the distortion amount detected by the distortion gauge 23 in response to the shape change of the battery pack 100. That is, the sensitivity of detecting the distortion using the distortion detecting device 3 can be effectively improved. The present disclosure may also be carried out in such embodiment.

### Fourth Embodiment

A distortion detecting device 4 of the fourth embodiment of the present disclosure is explained by referring to FIG. 5C. In the description of the fourth embodiment, the parts different from the distortion detecting device 1 of the first embodiment are only explained, and the configurations which are similar to the distortion detecting device 1 are given the same numerical references and the explanation of these are skipped. That is, the configurations with no description in below are similar to the corresponding configurations of the distortion detecting device 1 of the first embodiment.

As shown in FIG. 5C, the distortion detecting device 4 of the fourth embodiment includes the first metal member 11, a distortion gauge 24, and an additional member 54. The distortion gauge 24 includes a second metal member 34 and the first distortion detector 41 (FIG. 2). The additional member 54 includes a third metal member 64. Note that, in FIG. 5C, the first distortion detector 41 of the distortion gauge 24 is not shown.

In the distortion detecting device 4, the relation between a width W2 of the second metal member 34 of the distortion gauge 24 and a width W3 of the third metal member 64 of the additional member 54 in the width direction of the first metal member 11 are different from that of the distortion detecting device 1 of the first embodiment. As shown in FIG. 5C, in the distortion detecting device 4, the width W3 of the third metal member 64 is longer than the width W2 of the second metal member 34 of the distortion gauge 24 (W2 < W3). The maximum length of the width W3 of the third metal member 64 of the additional member 54 is the width W1 of the first metal member 11.

The distortion gauge 24 (second metal member 34) and the additional member 54 (third metal member 64) are arranged so that the centers of gravity overlap with each other (the geometric centers of these overlap) in plan view. In other words, these are arranged at the same position in plan view. Also, the lengths L2 and L3 (see FIGS. 1A and 1C) of the distortion gauge 24 (second metal member 34) and the additional member 54 (third metal member 64) of the longitudinal direction of the first metal member 11 are the same.

Therefore, the distortion gauge 24 (second metal member 34) is entirely facing the additional member 54 (third metal member 64) across the first metal member 11. However, the additional member 54 (third metal member 64) has a portion which is not facing the distortion gauge 24 (second metal member 34) at both ends in the width direction of the first metal member 11.

As the width W3 of the third metal member 64 of the additional member 54 is wider than the width W2 of the second metal member 34 of the distortion gauge 24 (W2 < W3), it is possible to suppress the compression force, which is in the opposite direction of the tensile force acting on the first metal member 11, from acting on the distortion gauge 24. Thus, this enables to further increase the distortion amount detected by the distortion gauge 24. That is, the sensitivity of detecting the distortion by the distortion detecting device 4 can be effectively improved. The present disclosure may also be carried out in such embodiment.

### Fifth Embodiment

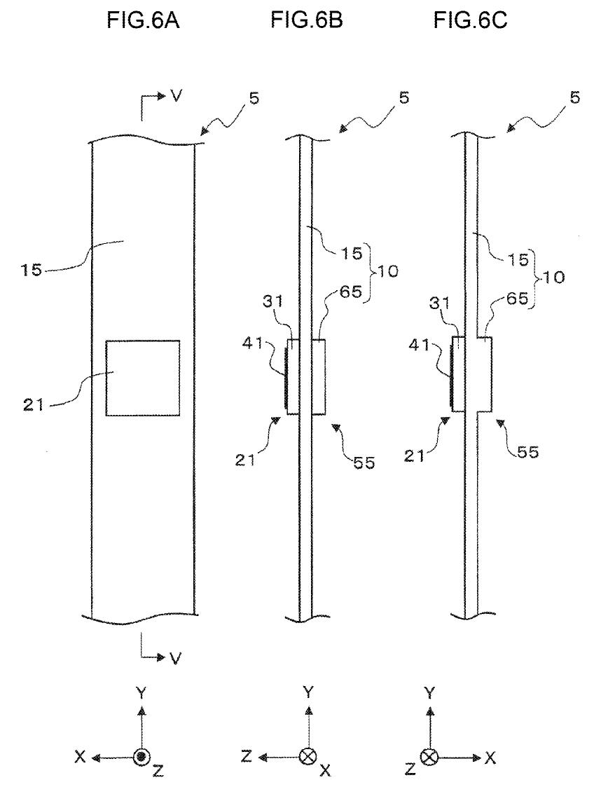

A distortion detecting device 5 of the fifth embodiment of the present disclosure is explained by referring to FIG. 6A to FIG. 6C. In the description of the fifth embodiment, the parts different from the distortion detecting device 1 of the first embodiment are only explained, and the configurations which are similar to the distortion detecting device 1 are given the same numerical references and the explanation of these are skipped. That is, the configurations with no description in below are similar to the corresponding configurations of the distortion detecting device 1 of the first embodiment.

As shown in FIGS. 6A to 6C, in the distortion detecting device 5 according to the fifth embodiment, the first metal member 11 and the third metal member 61 of the additional member 51 of the first embodiment are formed integrally. That is, the distortion detecting device 5 includes an additional member incorporated metal member 10 and distortion gauge 21. The additional member incorporated metal member 10 includes a first metal member portion 15 and a third metal member portion 65. The configuration and the function of the first metal member portion 15 are similar to those of the first metal member 11 of the first embodiment. The configuration and the function of the third metal member portion 65 are similar to the third metal member 61 of the first embodiment. In the distortion detecting device 5, the third metal member portion 65 of the additional member incorporated metal member 10 corresponds to the additional member 55.

Regarding the distortion detecting device 5 having such configuration, at the backside of the surface where the distortion gauge 21 of the additional member incorporated metal member 10 is provided, the third metal member portion 65 is arranged in a raised form with respect to the first metal member portion 15 of the additional member incorporated metal member 10. Thus, it is possible to suppress the compression force from acting on the distortion gauge 21. The compression force is acting in the opposite direction of the tensile force acting on the first metal member portion 15 of the additional member incorporated metal member 10,. Hence, this enables to further increase the distortion amount detected by the distortion gauge 21. That is, the sensitivity of detecting the distortion using the distortion detecting device 5 can be effectively improved.

In the distortion detecting device 5 having such configuration, the first metal member 11 (first metal member portion 15) and the third metal member (third metal member portion 65) of the additional member 55 are integrally configured; therefore, a fewer number of parts is needed for configuring the distortion detecting device 5. Hence, a simple configuration is achieved. Consequently, the distortion detecting device 5 can be assembled easily. The present disclosure may also be performed in such embodiment.

### Sixth Embodiment

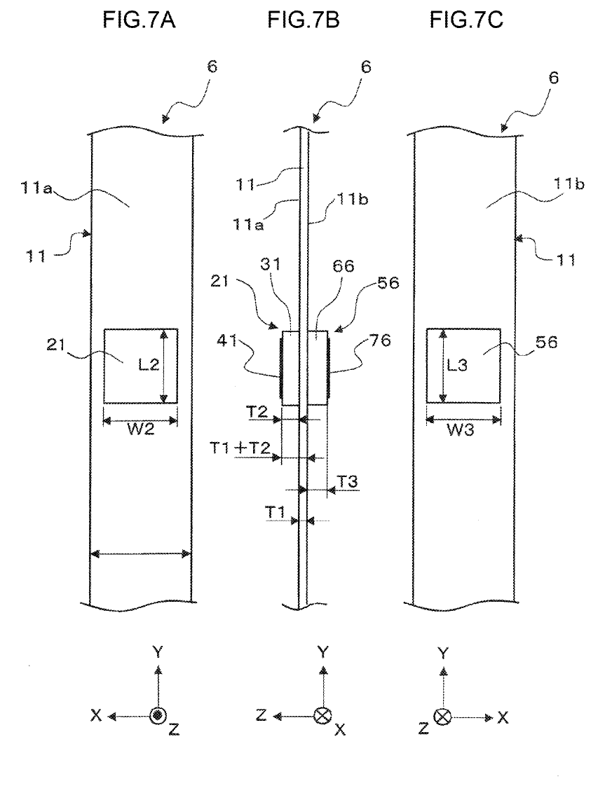

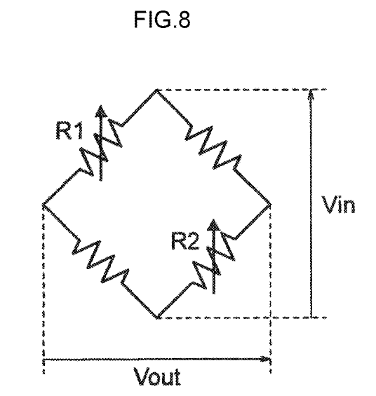

A distortion detecting device 6 of the sixth embodiment of the present disclosure is explained by referring to FIGS. 7A to 7C and 8. In the description of the sixth embodiment, the parts different from the distortion detecting device 1 of the first embodiment are only explained, and the configurations which are similar to the distortion detecting device 1 are given the same numerical references and the explanation of these are skipped. That is, the configurations with no description in below are similar to the configurations corresponding to the distortion detecting device 1 of the first embodiment.

The distortion detecting device 6 according to the sixth embodiment is different from the first embodiment as an additional member 56 includes a second distortion detector 76. As shown in FIG. 7B, the distortion detecting device 6 of the sixth embodiment includes the first metal member 11, the distortion gauge 21, and the additional member 56. The distortion gauge 21 includes the second metal member 31 and the first distortion detector 41. The additional member 56 includes a third metal member 66 and the second distortion detector 76 of the additional member 56. Note that, in FIGS. 7A and 7C, the first distortion detector 41 of the distortion gauge 21 and the second distortion detector 76 are not shown.

The second distortion detector 76 of the additional member 56 has a similar configuration as the first distortion detector 41 of the distortion gauge 21. Similarly to the first distortion detector 41 of the distortion gauge 21, the second distortion detector 76 detects the distortion of the first metal member 11. In addition to the distortion detected by the first distortion detector 41 of the distortion gauge 21, the distortion detected by the second distortion detector 76 of the additional member 56 is used to measure the distortion of the first metal member 11. Thereby, it is possible to further effectively measure the distortion of the first metal member 11 caused by the force acting on the first metal member 11 due to the shape change of the measurement object (for example, the battery pack 100 shown in FIG. 3).

Similarly to the third metal member 61 of the additional member 51 of the first embodiment, the thickness T3 of the third metal member 66 is thicker than the thickness T2 of the second metal member 31 of the distortion gauge 21 (T2 < T3), and also thicker than the thickness T1 of the first metal member 11 (T1 < T3). In the distortion detecting device 6 of the sixth embodiment, particularly the thickness T3 of the third metal member 66 is equal to or thinner than a sum of the thickness T2 of the second metal member 31 of the distortion gauge 21 and the thickness T1 of the first metal member 11 ((T3 ≤ T1+T2) .

The second distortion detector 76 is formed on an upper surface of the third metal member 66 (the surface on the Z-axis negative side, that is the surface of the second metal member 66 where the first metal member 11 is not contacting), and detects the distortion of the first metal member 11 via the distortion of the third metal member 66. In the present embodiment, the configuration of the second distortion detector 76 is similar to the configuration of the first distortion detector 41 of the distortion detector 21. That is, as shown in FIG. 2, the second distortion detector 76 is fixed on the upper surface of the third metal member 66 via an insulation film 80. The second distortion detector 76 includes a resistance film 81 which is the distortion resistance film for detecting the distortion using the resistance change, and the electrodes 82 and 83 arranged at the both ends of the resistance film 81 and connected to the tapping wires 92 and 93. The voltage corresponding to the resistance R2 of the resistance film 81 of the second distortion detector 76 is detected by an exterior circuit via the electrodes 82 and 83 and the tapping wires 92 and 93; and based on the change in voltage, an distortion amount of the first metal member 11 is measured.

In the example shown in FIG. 2, the insulation film 80 of the additional member 56 is formed roughly on the entire upper surface of the third metal member 66; however, the insulation film 80 may be formed on the portion only where the resistance film 81 and the electrodes 82 and 83 are formed on the upper surface of the third metal member 66.

The resistance film 81 configuring the second distortion detector 76 is formed by forming a functional film on the insulation film 80 using a spattering method, a vacuum deposition method, a CVD method, a sol-gel method, etc., and then by patterning using a photo-patterning method, etc.

The second distortion detector 76 is not necessarily limited to be formed as the resistance film 81 for simply measuring the resistance, and for example it may be formed by having a Wheatstone bridge circuit or so configured of a plurality of distortion resistance films.

In the distortion detecting device 6 having such configuration, the voltages corresponding to the resistances R1 and R2 of the resistance film 81 detected by the first distortion detector 41 of the distortion gauge 21 and by the second distortion detector 76 of the additional member 56 are input to a signal processing circuit arranged outside through the tapping wires 92 and 93, respectively. The tapping wires 92 and 93 correspond to the first distortion detector 41 and the second distortion detector 76, respectively. Then, the voltages are used for measuring the distortion amount of the first metal member 11.

As one example of the signal processing circuit used for the distortion detecting device 6, a circuit shown in FIG. 8 may be used. The circuit shown in FIG. 8 is a circuit obtaining the output which is a sum of the voltage corresponding to the resistance R1 of the resistance film 81 of the first distortion detector 41 of the distortion gauge 21 (output of the first distortion detector 41) and the voltage corresponding to the resistance R2 of the resistance film 81 of the second distortion detector 76 of the additional member 56 (output of the second distortion detector 76).

In the distortion detecting device 6 of the present embodiment, as mentioned in above, the thickness T1 of the first metal member 11, the thickness T2 of the second metal member 31, and the thickness T3 of the third metal member 66 satisfy the relation of T1 < T3, T2 < T3, and T3 ≤ T1 + T2. When such relations (conditions) are satisfied, in response to the change in distortion of the first metal member 11, the resistance R1 of the resistance film 81 of the first distortion detector 41 of the distortion gauge 21 and the resistance R2 of the resistance film 81 of the second distortion detector 76 of the additional member 56 experimentally change in the same direction in terms of positive/negative direction of the values.

Thus, using the circuit shown in FIG. 8, by measuring the distortion of the first metal member 11 based on the voltage which is a sum of the voltage corresponding to the resistance R1 of the resistance film 81 on the first distortion detector 41 of the distortion gauge 21 and the voltage corresponding to the resistance R2 of the resistance film 81 on the second distortion detector 76 of the additional member 56, a large voltage change can be obtained in response to the change in distortion of the first metal member 11. Thus, the sensitivity of the distortion detecting device 6 can be substantially improved.

As such, in the distortion detecting device 6 of the present embodiment, the distortion of the first metal member 11 is detected by providing the second distortion detector 76 to the additional member 56 in addition to providing the first distortion detector 41 to the distortion gauge 21. Hence, the distortion of the first metal member 11 is detected based on the resistance change of the resistance films 81 of these two distortion detectors; thus, the distortion of the first metal member 11 can be detected with even higher sensitivity.

Particularly, in the distortion detecting device 6, it has a configuration that the thickness T1 of the first metal member 11, the thickness T2 of the second metal member 31 of the distortion gauge 21, and the thickness T3 of the third metal member 66 of the additional member 56 satisfy the relation of T2 < T3 ≤ T1 + T2, and the distortion is detected using the circuit shown in FIG. 8 obtaining an output which is the sum of the output of the first distortion detector 41 and the output of the second distortion detector 76. Thus, the distortion of the first metal member 11 can be detected with even higher sensitivity.

### Seventh Embodiment

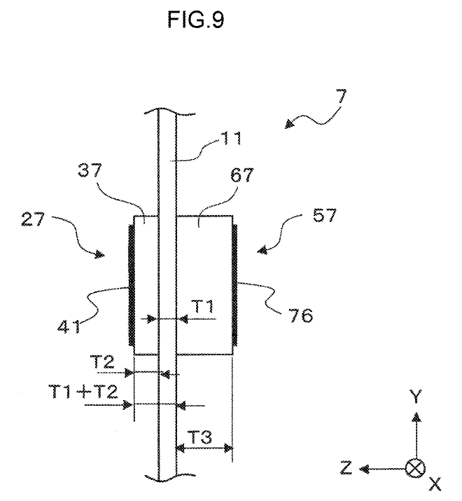

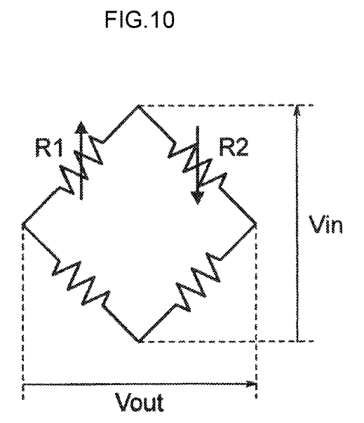

A distortion detecting device 7 of the seventh embodiment of the present disclosure is explained by referring to FIG. 9 and FIG. 10. In the description of the seventh embodiment, the parts different from the distortion detecting device 6 of the sixth embodiment are only explained, and the configurations which are similar to the distortion detecting device 6 are given the same numerical references and the explanation of these are skipped. That is, the configurations with no description in below are similar to the corresponding configurations of the distortion detecting device 6 of the sixth embodiment.

As shown in FIG. 9, the distortion detecting device 7 of the seventh embodiment includes the first metal member 11, a distortion gauge 27, and an additional member 57. The distortion gauge 27 includes a second metal member 37 and the first distortion detector 41. The additional member 57 includes a third metal member 67 and the second distortion detector 76.

In the distortion detecting device 7, the relation between a thickness T1 of the first metal member 11, a thickness T2 of the second metal member 37 of the distortion gauge 27, and a thickness T3 of the third metal member 67 of the additional member 57 are different from that of the distortion detecting device 6 of the sixth embodiment. The thickness T3 of the third metal member 67 (63) is thicker than the thickness T2 of the second metal member 37 (33) (T2 < T3), which is the same as in the case of the distortion detecting device 6 of the sixth embodiment. In the distortion detecting device 7, the thickness T3 of the third metal member 67 is thicker than the thickness (T1 + T2) which is a sum of the thickness T1 of the first metal member 11 and the thickness T2 of the second metal member 37 of the distortion gauge 27 (T1 + T2 < T3).

Even in the case that the thickness T1 of the first metal member 11, the thickness T2 of the second metal member 37, and the thickness T3 of the third metal member 67 are in such relation, by providing the additional member 57, the distortion of the first metal member 11 can be detected with high sensitivity, which is similar to the distortion detecting device 6 of the sixth embodiment.

As one example of the signal processing circuit used for the distortion detecting device 7, a circuit shown in FIG. 10 can be used. The circuit shown in FIG. 10 is a circuit obtaining an output which is a difference between the voltage corresponding to the resistance R1 of the resistance film 81 on the first distortion detector 41 of the distortion gauge 27 (output of the first distortion detector 41) and the voltage corresponding to the resistance R2 of the resistance film 81 on the second distortion detector 76 of the additional member 57 (output of the second distortion detector 76).

In the distortion detecting device 7, the thickness T1 of the first metal member 11, the thickness T2 of the second metal member 37, and the thickness T3 of the third metal member 67 satisfy T1 + T2 < T3; thus, the resistance R1 of the resistance film 81 of the first distortion detector 41 and the resistance R2 of the resistance film 81 of the second distortion detector 76, in response to the change in distortion of the first metal member 11, experimentally change in the same direction in terms of positive/negative direction of the values.

Thus, using the circuit shown in FIG. 10, by measuring the distortion of the first metal member 11 based on the voltage which is a difference between the voltage corresponding to the resistance R1 of the resistance film 81 on the first distortion detector 41 of the distortion gauge 27 and the voltage corresponding to the resistance R2 of the resistance film 81 on the second distortion detector 76 of the additional member 57, a large voltage change can be obtained in response to the change in distortion of the first metal member 11. Thus, the sensitivity of the distortion detecting device 7 can be substantially improved. The present disclosure may also be carried out in such embodiment.

### Eighth Embodiment

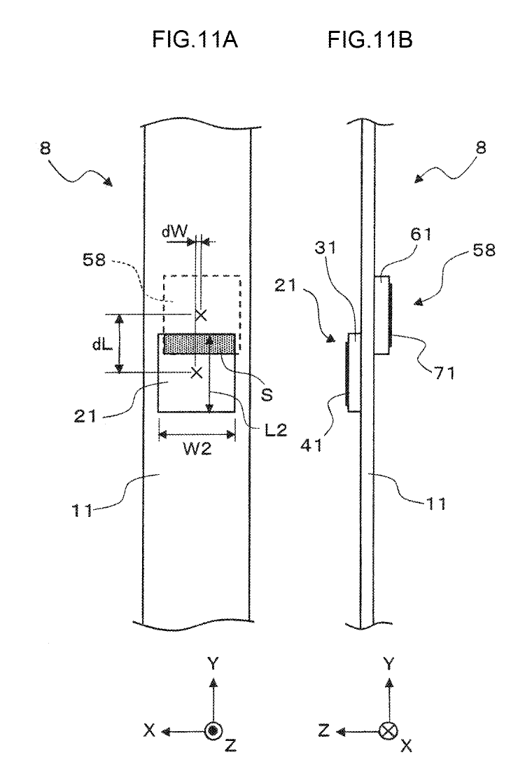

A distortion detecting device 8 of the eighth embodiment of the present disclosure is explained by referring to FIG. 11A and FIG. 11B. In the description of the eighth embodiment, the parts different from the distortion detecting device 6 of the sixth embodiment are only explained, and the configurations which are similar to the distortion detecting device 6 are given the same numerical references and the explanation of these are skipped. That is, the configurations with no description in below are similar to the corresponding configurations of the distortion detecting device 6 of the sixth embodiment.

As shown in FIGS. 11A and 11B, the distortion detecting device 8 of the eighth embodiment includes the first metal member 11, the distortion gauge 21, and an additional member 58. The distortion gauge 21 includes the second metal member 31 and the first distortion detector 41. The additional member 58 includes a third metal member 61 and the second distortion detector 76. Also, in plan view, a plan shape of the distortion gauge 21 and a plan shape of the additional member 58 are the same.

The arrangement of the additional member 58 in the distortion detecting device 8 is different from that of the distortion detecting device 6. As shown in FIGS. 11A and 11B, in the distortion detecting device 8, the position of the additional member 58 and the position of the distortion gauge 21 are shifted in plan view. As shown in FIG. 11A, in plan view, compared to the position of the center of gravity of the distortion gauge 21, the position of the center of gravity of the additional member 58 is shifted by a distance dL in the longitudinal direction of the first metal member 11. Also, compared to the position of the center of gravity of the distortion gauge 21, the position of the center of gravity of the additional member 58 is shifted by a distance dW in a width direction of the first metal member 11.

The distance dL of the additional member 58 in the longitudinal direction of the first metal member 11 is smaller than the length L2 of the distortion gauge 21 in the longitudinal direction of the first metal member 11 (dL < L2). Also, the distance dW of the additional member 58 in the width direction of the first metal member 11 is smaller than the length W2 of the distortion gauge 21 in the width direction of the first metal member 11 (dW< W2), and the additional member 58 can be arranged within the W1 of the first metal member 11.

Under such conditions, the distortion gauge 21 and the additional member 58 partially overlap with each other in plan view. In the example shown in FIG. 11A, the additional member 58 and the distortion gauge 21 overlap with each other in an area S. That is, the additional member 58 and the distortion gauge 21 are facing each other across the first metal member 11 in the area S.

Even in such configuration, as long as the distortion gauge 21 and the additional member 58 are at least partially facing each other across the first metal member 11, the distortion of the first metal member 11 can be detected with high sensitivity. The present disclosure may also be performed in such embodiment.

### Modified Examples

The present disclosure is not limited to the aforementioned embodiments, and various modifications are also possible.

For example, in the aforementioned embodiments, the second metal members 31 to 37 of the distortion gauges 21 to 27, the third metal members 61 to 67 of the additional members 51 to 58, and the third metal member portion 65 have rectangle plan shape; however, the plan shapes may be any other plan shapes such as a circular shape and an oval shape. At least part of each of the third metal members 61 to 67 of the additional members 51 to 58 and the third metal member portion 65 face at least part of one corresponding second metal members 31 to 37 of the distortion gauges 21 to 27. As long as this condition is satisfied, effects according to the present disclosure are attained. Therefore, under such condition, the second metal members 31 to 37 of the distortion gauges 21 to 27, the third metal members 61 to 67 of the additional members 51 to 58, and the third metal member portion 65 may have any plan shape.

Also, regarding the distortion gauges 21 to 27, the first metal member 41 may be formed on the resin film instead of the second metal member. In this case, the distortion gauges 21 to 27 include the resin film, the resistance film 81 as a distortion resistance film formed on the resin film, and the electrodes 82 and 83 connected with the tapping wires 92 and 93 arranged at both ends of the resistance film 81.

### Notes

As is understood from the above description, the present specification discloses the following.

A distortion detecting device, including:

a first metal member having a plate form,

a distortion gauge including a first distortion resistance film and provided on one surface of the first metal member, and

an additional member provided on an other surface of the first metal member such that the additional member and the distortion gauge are at least partially facing each other across the first metal member.

The distortion detecting device according to [1], wherein the distortion gauge includes a second metal member having a plate form and provided with the first distortion resistance film, and

the additional member includes a third metal member having a plate form.

The distortion detecting device according to [2], wherein a thickness T2 of the second metal member and a thickness T3 of the third metal member satisfy T2 < T3.

The distortion detecting device according to [2], wherein a thickness T2 of the second metal member and a thickness T3 of the third metal member satisfy T2 > T3.

The distortion detecting device according to any one of [2] to [4], wherein a thickness T1 of the first metal member and the thickness T3 of the third metal member satisfy T1 < T3.

The distortion detecting device according to any one of [2] to [5], wherein a length L2 of the second metal member in a longitudinal direction of the first metal member and a length L3 of the third metal member in the longitudinal direction of the first metal member satisfy L2 < L3.

The distortion detecting device according to any one of [2] to [6], wherein a width W2 of the second metal member in a direction perpendicular to a longitudinal direction of the first metal member and a width W3 of the third metal member in a direction perpendicular to the longitudinal direction of the first metal member satisfy W2 < W3 in plan view in a thickness direction of the first metal member.

The distortion detecting device according to any one of [1] to [7], wherein the additional member is provided with a second distortion resistance film.

The distortion detecting device according to any of [2] to [7], wherein the additional member is provided with a second distortion resistance film, and

a thickness T1 of the first metal member, a thickness T2 of the second metal member, and a thickness T3 of the third metal member satisfy T2 < T3 ≤ T1 + T2.

The distortion detecting device according to any one of [2] to [7], wherein the additional member is provided with a second distortion resistance film, and

a thickness T1 of the first metal member, a thickness T2 of the second metal member, and a thickness T3 of the third metal member satisfy T1 + T2 < T3.

The distortion detecting device according to any one of [1] to [7], wherein the additional member is not provided with a distortion resistance film.

The distortion detecting device according to any one of [2] to [7], [9], and [10], wherein the second metal member and the third metal member are made of stainless steel.

The distortion detecting device according to [1], wherein the additional member includes a third metal member having a plate form, and the third metal member and the first metal member are integrally formed; or the distortion detecting device according to any one of [2] to [7], [9], [10], and [12], wherein the additional member includes a third metal member having a plate form, and the third metal member and the first metal member are integrally formed.

The distortion detecting device according to [1], wherein the distortion gauge includes the first distortion resistance film formed on a resin film.

A distortion detecting device, including:

a first metal member having a plate form,

a distortion gauge including a first detector and provided on one surface of the first metal member, and

an additional member provided on an other surface of the first metal member such that the additional member and the distortion gauge are at least partially facing each other across the first metal member.

The distortion detecting device according to [15], wherein the additional member is provided with a second detector.

### Exambples

(1) Regarding a distortion detecting device 3 of the third embodiment described by referring to FIG. 5B, that is, regarding the distortion detecting devices with different lengths L3 of the third metal members 63 of the additional members 53, a predetermined tensile force (200 N) was applied on each first metal member 11 to measure the distortion in a direction parallel to a tensile direction using a first distortion detector 41 of the distortion gauge 23. As the first metal member 11, it was not in a loop-form and it was used in a form having a predetermined length.

Shapes of the first metal member 11, the second metal member portion 33 of the distortion gauge 23, and the third metal member 63 of the additional member 53 were as follows.

The first metal member (11): Length: 150 mm, Width: 7.9 mm, Thickness (T1):0.25 mm

The second metal member (33): Length:(L2): 5mm, Width (W2): 5 mm, Thickness (T2): 0.1 mm

The third metal member (63): Length:(L3): 3 mm, 5 mm, 5 mm, 7 mm, Width (W3): 5 mm, Thickness (T3): 0.35 mm

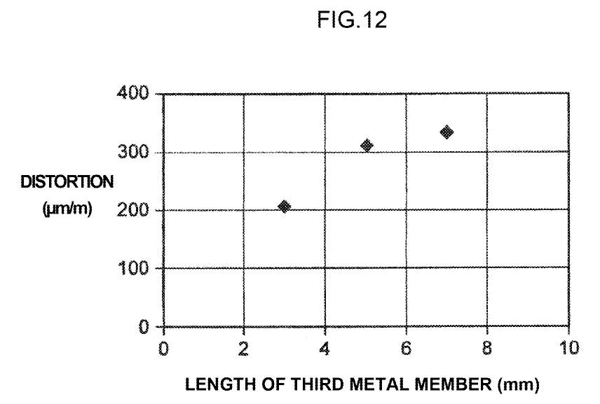

Experiment results are shown in FIG. 12. As obvious from FIG. 12, the longer the length L3 of the third metal member 63, the larger the detected distortion value.

That is, the longer the length L3 of the third metal member 63, the more improved the sensitivity in response to the distortion of the detection object.

(2) Regarding a distortion detecting device 4 of the fourth embodiment described by referring to FIG. 5C, that is, regarding the distortion detecting devices with different width W3 of the third metal members 64 of the additional members 54, a predetermined tensile force (200 N) was applied on each first metal member 11 to measure the distortion in a direction parallel to a tensile direction using a first distortion detector 41 of the distortion gauge 24. As the first metal member 11, it was not in a loop-form, and it was used in a form having a predetermined length.

Shapes of the first metal member 11, the second metal member portion 34 of the distortion gauge 24, and the third metal member 64 of the additional member 54 were as follows.

The first metal member (11): Length: 150 mm, Width: 7.9 mm, Thickness (T1):0.25 mm

The second metal member (34): Length:(L2): 5 mm, Width (W2): 5 mm, Thickness (T2): 0.1 mm

The third metal member (64): Length:(L3): 5 mm, Width (W3): 3 mm, 5 mm, 7 mm, Thickness (T3): 0.35 mm

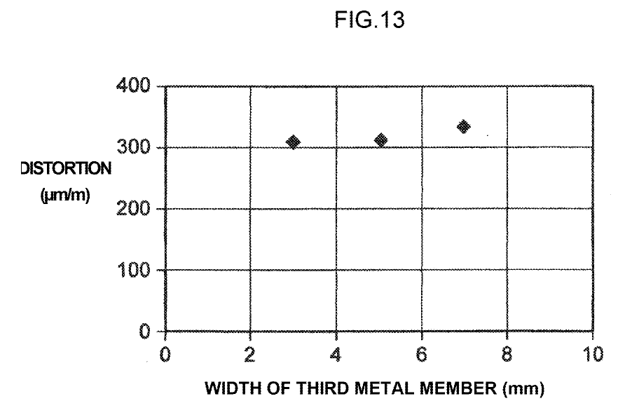

Experiment results are shown in FIG. 13. As obvious from FIG. 13, the longer the width W3 of the third metal member 64, the larger the detected distortion value. That is, the longer the width W3 of the third metal member 64, the more improved the sensitivity with respect to the distortion of the detection object.

(3) Regarding a distortion detecting device 6 of the sixth embodiment described by referring to FIGS. 7A to 7C, that is, regarding a distortion detecting device 7 of the seventh embodiment described by referring to FIG. 9, to the distortion detecting devices with different thicknesses T3 of the third metal members 66 and 67 of the additional members 56 and 57, a predetermined tensile force (200 N) was applied on each first metal member 11 to measure the distortion in a direction parallel to a tensile direction using a first distortion detector 41 of the distortion gauges 21 and 27 and the second distortion detector 76 of the additional members 56 and 57. As the first metal member 11, it was not in a loop-form, and it was used in a form having a predetermined length.

Shapes of the first metal member 11, the second metal member portions 31 and 37 of the distortion gauges 21 and 27, and the third metal members 66 and 67 of the additional members 56 and 57 were as follows.

The first metal member (11): Length: 150 mm, Width: 7.9 mm, Thickness (T1):0.25 mm

The second metal member (31 and 37): Length:(L2): 5 mm, Width (W2): 5 mm, Thickness (T2): 0.1 mm

The third metal member (66 and 67): Length:(L3): 5 mm, Width (W3): 5 mm, Thickness (T3): 0 to 0.5 mm

Note that, the distortion detecting device having the thickness T3 of the third metal members 66 and 67 between 0.1 mm or less and 0 mm does not correspond to the distortion detecting devices 6 and 7 of the sixth and seventh embodiments, since the configuration other than the thickness T3 of the third metal members 66 and 67 were the same as the distortion detecting devices 6 and 7 of the sixth and seventh embodiment, for convenience, the same reference numbers are used for explaining this distortion detecting device. The thickness T3 of the third metal members 66 and 67 of 0 mm means that the additional member was not installed, and the distortion measured value of the device having such configuration indicates the distortion measured value according to the distortion detecting device as Comparative example.

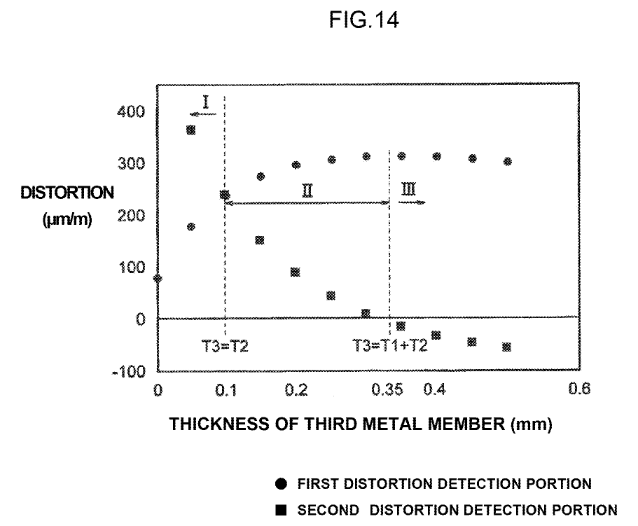

Experiment results are shown in FIG. 14. As obvious from FIG. 14, in the configuration without the additional member (T3 = 0 mm), the distortion values detected by the distortion gauges 21 and 27 were small and the sensitivity was low. In the configuration provided with the additional member (T3 ≥ 0.05 mm), a larger distortion value was detected by the distortion gauges 21 and 27. Also, in the range where the thickness T3 of the third metal members 66 and 67 was larger than the thickness T2 (= 0.1 mm) of the second metal members 31 and 37 (T2 < T3), a larger distortion value was detected by the distortion gauges 21 and 27.

As in the case of the distortion detecting device 6 of the sixth embodiment discussed using FIGS. 7A to 7C, when the thickness T3 of the third metal member 66 was equal to or less than a sum of the thickness T1 (= 0.25 mm) of the first metal member 11 and the thickness T2 (= 0.1 mm) of the second metal member 31 (that is, T3 ≤ T1 + T2 = 0.35 mm), as shown in the range I and the range II of FIG. 14, the thicker the thickness T3 of the third metal member 66, the larger the distortion value detected by the first distortion detector 41 of the distortion gauge 21, and the smaller the distortion value detected by the second distortion detector 76 of the additional member 56. The distortion value detected by the first distortion detector 41 of the distortion gauge 21 and the distortion value detected by the second distortion detector 76 of the additional member 56 were both positive values.

Thus, under the conditions of the range I and the range II shown in FIG. 14, as the signal processing circuit used for the distortion detecting device 6, the circuit discussed in above explained using FIG. 8 was used; that is, a circuit for measuring the distortion amount which is based on a sum of the voltage corresponding to the resistance R1 of the resistance film 81 on the first distortion detector 41 of the distortion gauge 21 and the voltage corresponding to the resistance R2 of the resistance film 81 on the second distortion detector 76 of the additional member 56 was used. Thereby, the sensitivity for measuring the distortion amount can be enhanced.

Also, as in the case of the distortion detecting device 7 of the seventh embodiment explained using FIG. 9, when the thickness T3 of the third metal member 67 was less than a sum of the thickness T1 (= 0.25 mm) of the first metal member 11 and the thickness T2 (= 0.1 mm) of the second metal member 37 (that is, T3 ≤ T1 + T2 = 0.35 mm), the distortion value detected by the second distortion detector 76 of the additional member 57 was a negative value which was opposite in terms of positive/negative of the distortion value detected by the first distortion detector 41 of the distortion gauge 27.

Thus, under the condition of a range III shown in FIG. 14, as a signal processing circuit used for the distortion detecting device 7, the circuit discussed in above using FIG. 10 was used; that is a circuit which measured the distortion amount based on the difference between the voltage corresponding to the resistance R1 of the resistance film 81 on the first distortion detector 41 of the distortion gauge 27 and voltage corresponding to the resistance R2 of the resistance film 81 on the second distortion detector 76 of the additional member 57 was used. Thereby, the sensitivity for measuring the distortion amount can be enhanced.

As understood from the experiment result shown in FIG. 14, by appropriately processing the output of the first distortion detector 41 of the distortion gauges 21 and 27 and the output from the second distortion detector 76 of the additional members 56 and 57, based on the relation between the thickness T1 of the first metal member 11, the thickness T2 of the second metal members 31 and 37, and the thickness T3 of the third metal members 66 and 67, it is possible to attain the distortion detecting device capable of measuring, with high sensitivity, the distortion amount which is parallel to the tensile direction of the first metal member 11.

(4) For example, in regards with Comparative examples relating to the distortion detecting device 1 shown in FIGS. 1A to 1C, that is, to the distortion detecting devices with different thicknesses T1 of the first metal members 11, a predetermined tensile force (200 N) was applied on each of the first metal member 11 to measure the distortion in a direction parallel to a tensile direction using a first distortion detector 41 of the distortion gauge 21. The additional member 51 was not installed. As the first metal member 11, it was not in a loop-form, and it was used in a form having a predetermined length.

Shapes of the first metal member 11 and the second metal member portion 31 of the distortion gauge 21 were as follows.

The first metal member (11): Length: 150 mm, Width: 7.9 mm, Thickness (T1): 0.1mm, 0.25mm 0.4 mm

The second metal member (31): Length:(L2): 5 mm, Width (W2): 5 mm, Thickness (T2): 0.1 mm

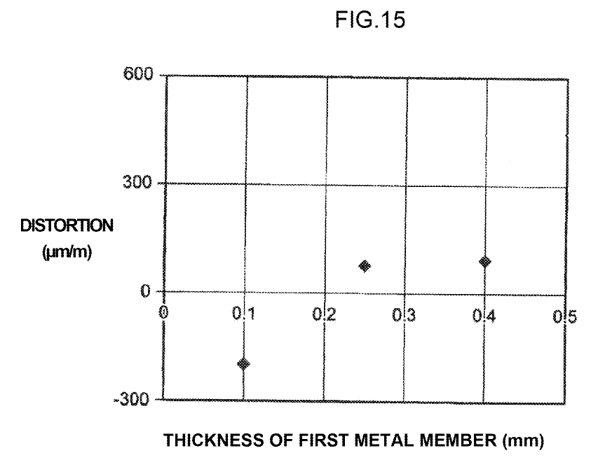

Experiment results are shown in Table 15. In the case of the first metal member 11 to which the distortion gauge 21 was not installed, even though the distortion amount of the first metal member 11 increased as the thickness T1 of the first metal member 11 became thinner, as it is obvious from the experiment result shown in FIG. 15, the distortion value detected by the distortion gauge 21 decreases as the thickness T1 of the first metal member 11 became thinner. Hence, this indicates that the sensitivity against the distortion of detection object had decreased.

However, as mentioned in above by referring to FIG. 14, by installing the additional member 51 to such distortion detecting device, the detected value detected by the distortion gauge 21 was increased, and the sensitivity against the distortion of the detected object was enhanced. Note that, the distortion measurement value when the thickness T1 of the first metal member 11 was 0.25 mm shown in FIG. 15 corresponds to the distortion measured value when the thickness T3 of the third metal member was 0 (that is, the additional member was not installed) shown in FIG. 14.

(5) Regarding a distortion detecting device 3 of the third embodiment and a distortion detecting device 4 of the fourth embodiment described in above using FIGS. 5B and 5C, that is, regarding the distortion detecting devices having different areas of the third metal members 63 and 64 of the additional members 53 and 54, a predetermined tensile force (200 N) was applied on each first metal member 11 to measure distortion in a direction parallel to a tensile direction using the distortion gauges 23 and 24 including the second distortion detectors 33 and 34. The shape of the additional member (third metal member) was different from the additional members 53 and 54 shown in FIGS. 5B and 5C, and the length L3 and the width W3 of the third metal member were varied to form square-shaped third metal members (additional members) with a plurality of types having different areas of plan shapes. As the first metal member 11, it was not in a loop-form, and it was used in a form having a predetermined length.

Shapes of the first metal member 11, the second metal members 33 and 34 of the distortion gauges 23 and 24, and the third metal members 63 and 64 of the additional members 53 and 54 were as follows.

The first metal member (11): Length: 150 mm, Width: 7.9 mm, Thickness (T1):0.25 mm

□The second metal member (33 and 34): Length:(L2): 5 mm, Width (W2): 5 mm, Thickness (T2): 0.1 mm

The third metal member (53 and 54): Squares having length (L3) 3 mm × width (W3) 3 mm, length (L3) 5 mm × width (W3) 5 mm, and length (L3) 7 mm × width (W3) 7 mm, Thickness (T3): 0.35 mm

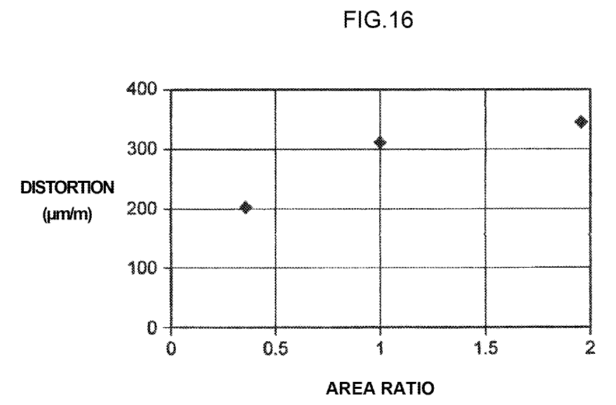

Experiment results are shown in Table 16. In FIG. 16, the horizontal axis shows an area ratio ((L3 × W3)/ (L2 × W2) between an area of the second metal members 33 and 34 (L2 × W2) and an area of the third metal members 63 and 64 (L3 × W3). Therefore, when the area ratio was 1, this means that the area of the second metal members 33 and 34 and the area of the third metal members 53 and 54 were the same, which means that the second metal members 33 and 34 completely overlapped the third metal members 53 and 54 in plan view. When the area ratio was less than 1, the third metal member was smaller than the second metal member, which means part of the second metal members 33 and 34 were not facing the third metal members 63 and 64. Also, when the area ratio was larger than 1, the third metal members 63 and 64 were larger than the second metal members 33 and 34, which means part of the third metal members 63 and 64 were not facing the second metal members 33 and 34.

As obvious from FIG. 16, the larger the areas of the third metal members 63 and 64, the larger the detected distortion value, and the more enhanced the sensitivity against the distortion of the detection object.

(6) In regards with a distortion detecting device 8 of the eighth embodiment described by referring to FIGS. 11A and 11B, the additional member 58 and the distortion gauge 21 were arranged at shifted positions. Then, a predetermined tensile force (200 N) was applied on the first metal member 11 to measure the distortion in a direction parallel to a tensile direction using the first distortion detector 41 of the distortion gauge 21. The first metal member 11 was not in a loop-form, and it was used in a form having a predetermined length.

Shapes of the first metal member 11, the second metal member portion 31 of the distortion gauge 21, and the third metal member portion 61 of the additional member 58 were as follows.

The first metal member (11): Length: 150 mm, Width: 7.9 mm, Thickness (T1):0.25 mm

The second metal member (31): Length:(L2): 5 mm, Width (W2): 5 mm, Thickness (T2): 0.1 mm

The third metal member (61): Length:(L3): 5 mm, Width (W3): 5 mm, Thickness (T3): 0.35 mm

In regards with the positions of the additional member 58, the position of the center of gravity in plan view was shifted by 0 mm, 2.5 mm, 4.5 mm, and 5 mm in the longitudinal direction of the fist metal member 11 with respect to the position of the center of gravity of the distortion gauge 21. That is, the shifted amount dW was zero, and dL was varied in four different distances of 0 mm, 2.5 mm, 4.5 mm, and 5 mm. The condition that the position was shifted by 0 mm means that in reality it was not shifted, and the additional member 58 and the distortion gauge 21 completely overlapped with each other in plan view. Also, the condition that the position was shifted by 5 mm means that the additional member 58 and the distortion gauge 21 did not overlapped with each other in plan view (not facing each other) since the lengths L2 and L3 of the additional member 58 and the distortion gauge 21 were 5 mm.

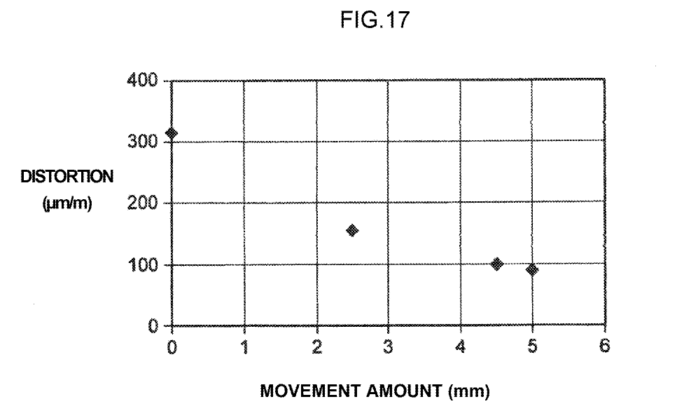

Experiment results are shown in Table 17. As obvious from FIG. 17, the more shifted the additional member 58 was from the distortion gauge 21, the smaller the detected distortion value, and the lower the sensitivity against the distortion of the detection object. However, from the comparison between the condition where the additional member and the distortion gauge were shifted by 4.5 mm and by 5 mm (that is, the additional member 58 and the distortion gauge 21 were not overlapping), it can be understood that just by having a small overlapping portion, the detected distortion amount can be increased, and the effect of enhancing the sensitivity against the distortion of the detection object can be achieved.

### REFERENCE SIGNS LIST

1 to 8...Distortion detecting device

10...Additional member incorporated metal member

11...First metal member (binding band)

11a...First metal member front side

11b...First metal member backside

15...First metal member portion

21 to 27...Distortion gauge

31 to 37...Second metal member

41... First distortion detector

51 to 58…Additional member

61 to 67...Third metal member

65...Third metal member portion

76...Second distortion detector

80...Insulation film

81…Resistance film

82.83…Electrode

92, 93...Tapping wire

100...Battery pack

1101 to 110n...Unit cell

What is claimed is:

1. A distortion detecting device, comprising:
a first metal member having a plate form,
a distortion gauge including a first distortion resistance film and provided on one surface of the first metal member, and
an additional member provided on an other surface of the first metal member such that the additional member and the distortion gauge are at least partially facing each other across the first metal member.

2. The distortion detecting device according to claim 1, wherein the distortion gauge comprises a second metal member having a plate form and provided with the first distortion resistance film, and
the additional member comprises a third metal member having a plate form.

3. The distortion detecting device according to claim 2, wherein a thickness T2 of the second metal member and a thickness T3 of the third metal member satisfy T2 < T3.

4. The distortion detecting device according to claim 2, wherein a thickness T2 of the second metal member and a thickness T3 of the third metal member satisfy T2 > T3.

5. The distortion detecting device according to claim 2, wherein a thickness T1 of the first metal member and the thickness T3 of the third metal member satisfy T1 < T3.

6. The distortion detecting device according to claim 2, wherein a length L2 of the second metal member in a longitudinal direction of the first metal member and a length L3 of the third metal member in the longitudinal direction of the first metal member satisfy L2 < L3.

7. The distortion detecting device according to claim 2, wherein a width W2 of the second metal member in a direction perpendicular to a longitudinal direction of the first metal member and a width W3 of the third metal member in a direction perpendicular to the longitudinal direction of the first metal member satisfy W2 < W3 in plan view in a thickness direction of the first metal member.

8. The distortion detecting device according to claim 1, wherein the additional member is provided with a second distortion resistance film.

9. The distortion detecting device according to claim 2, wherein the additional member is provided with a second distortion resistance film, and
a thickness T1 of the first metal member, a thickness T2 of the second metal member, and a thickness T3 of the third metal member satisfy T2 < T3 ≤ T1 + T2.

10. The distortion detecting device according to claim 2, wherein the additional member is provided with a second distortion resistance film, and
a thickness T1 of the first metal member, a thickness T2 of the second metal member, and a thickness T3 of the third metal member satisfy T1 + T2 < T3.

11. The distortion detecting device according to claim 1, wherein the additional member is not provided with a distortion resistance film.

12. The distortion detecting device according to claim 2, wherein the second metal member and the third metal member are made of stainless steel.

13. The distortion detecting device according to claim 1, wherein the additional member comprises a third metal member having a plate form, and the third metal member and the first metal member are integrally formed.

14. The distortion detecting device according to claim 1, wherein the distortion gauge comprises the first distortion resistance film formed on a resin film.

15. A distortion detecting device, comprising:
a first metal member having a plate form,
a distortion gauge including a first detector and provided on one surface of the first metal member, and
an additional member provided on an other surface of the first metal member such that the additional member and the distortion gauge are at least partially facing each other across the first metal member.

16. The distortion detecting device according to claim 15, wherein the additional member is provided with a second detector.
